(19) United States
(12) Patent Application Publication
(10) Pub. No.: US 2011/0134636 A1
(43) Pub. Date: Jun. 9, 2011

(54) LED TRAFFIC SIGNAL DEVICE

(76) Inventors: KUO-HUI CHANG, Taoyuan City (TW); Chiung-Chih Nien, Kaohsiung (TW); Yu-Sheng Chen, Chiayi City (TW); Chung-Jung Chen, Taipei City (TW)

(21) Appl. No.: 12/705,533

(22) Filed: Feb. 12, 2010

(30) Foreign Application Priority Data
Dec. 7, 2009 (TW) 098222856

(51) Int. Cl. F21V 1/00

(52) U.S. Cl. 362/235

(57) ABSTRACT

The present invention provides a LED (Light Emitting Diodes) traffic signal device including a plurality of LEDs, a light-distribution lens and a Fresnel lens arranged between the plurality of LEDs and the light-distribution lens. The Fresnel lens is formed with multiple sections coaxially arranged with respect to an optical axis, every section having a different radius of curvature corresponding to a different focal distance.

### RELATED APPLICATIONS

This application claims the right of priority based on Taiwan Patent Application No. 098222856 entitled “LED TRAFFIC SIGNAL DEVICE”, filed on Dec. 7, 2009, which is incorporated herein by reference.

### FIELD OF INVENTION

The present invention relates to a traffic signal device, in particular to a traffic signal device having a Fresnel lens and a light-distribution lens.

### BACKGROUND OF THE INVENTION

An incandescent lamp used as the light source of a conventional traffic signal requires a considerable consumption of energy. Furthermore, the life of an incandescent lamp is short and thus leads to high maintenance cost, as it needs to be changed frequently. Light emitting diodes (LEDs) shows a high-energy efficiency and has a relatively long life. For these advantages, the LEDs have been widely used in place of the conventional incandescent lamp to be the light source of a traffic signal device.

A common LED traffic signal device typically has a Fresnel lens and a light-distribution lens. The Fresnel lens collects and refracts light emitted from the LEDs into a generally parallel beam of light. The generally parallel light passes through the light-distribution lens and turns into a spread light distributed within a desired angular range that is optimized for the pedestrians or vehicle operators to see the signal clearly.

A Fresnel lens of the common LED traffic signal device usually forms with aspherical surfaces and has only one focal point. In order to obtain such structure, the precision requirement for making its mold is considerably high and the related injection molding process is very complex. Therefore, there is a need of providing an innovative structure to improve the conventional technologies.

### SUMMARY OF THE INVENTION

It is accordingly an object of the present invention to provide a traffic signal device having a Fresnel lens formed with spherical surfaces corresponding to multiple focal distances. Compared to the conventional design of aspherical surface, the present invention provides a lower cost structure because the mold of the Fresnel lens is easy-making and the related injection molding process is relatively simple.

In one aspect, the present invention provides a LED (Light Emitting Diodes) traffic signal device including a plurality of LEDs, a light-distribution lens and a Fresnel lens arranged between the plurality of LEDs and the light-distribution lens. The Fresnel lens is formed with multiple sections coaxially arranged with respect to an optical axis, every section having a different radius of curvature corresponding to a different focal distance.

In addition to the aspect as above, the present invention still comprises other aspects to address other problems in the art.

Another aspect of the present invention is to provide a plurality of light emitting diodes; a light-distribution lens; and a Fresnel lens arranged between the plurality of LEDs and the light-distribution lens. The light-distribution lens has a light-incident surface formed with multiple first convex units facing the plurality of light emitting diodes, each first convex unit having at least two curved areas defined by different curvatures.

The invention still includes other aspects to resolve other problems, some of which will be described in detail together with the abovementioned aspects in the following detail description.

### BRIEF DESCRIPTION OF THE DRAWINGS

FIG. 1 is a cross-sectional view of a LED signal device in accordance with one embodiment of the present invention.

FIG. 2 is a plan view illustrating an inner curved side of a Fresnel lens in accordance with FIG. 1.

FIG. 3A is a plan view illustrating an outer curved side of a Fresnel lens in accordance with FIG. 1.

FIG. 3B is a partial cross-sectional view along the dotted line I-I′ of FIG. 3A.

FIG. 4 is a plan view of a light-incident surface of a light-distribution lens in accordance with FIG. 1

### DETAILED DESCRIPTION OF THE INVENTION

The preferred embodiments of the present invention will now be described in greater details by referring to the drawings that accompany the present application. It should be noted that the features illustrated in the drawings are not necessarily drawn to scale. Descriptions of well-known components, materials, and process techniques are omitted so as to not unnecessarily obscure the embodiments of the invention.

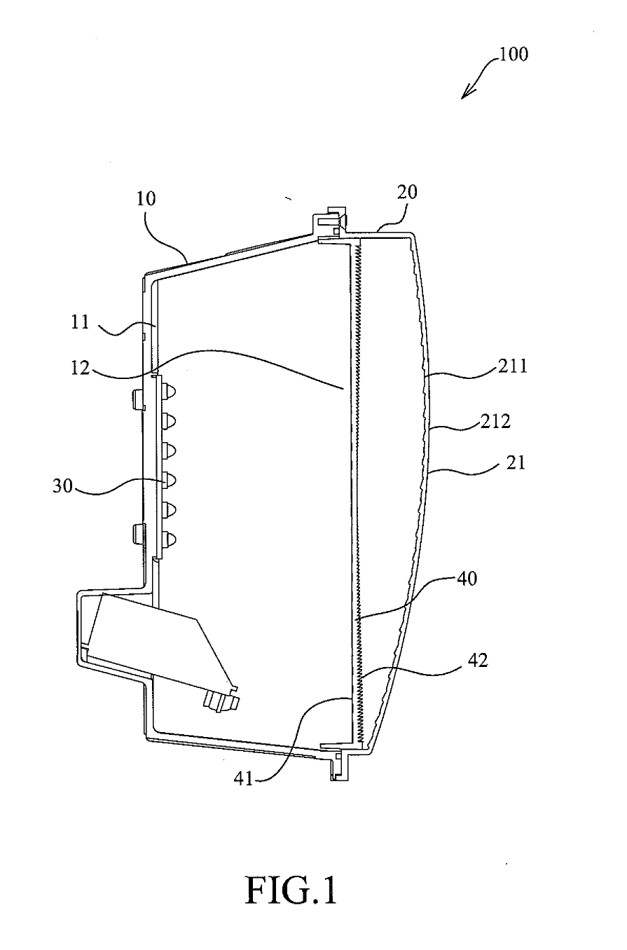

FIG. 1 is a cross-sectional view illustrating a LED traffic signal device 100 in accordance with one embedment of the present invention. As shown in FIG. 1, the LED traffic signal device 100 includes a rear cover 10 and a front cover 20. The rear cover 10 forms with an inner wall 11 and an opening 12 opposite to the inner wall 11. The front cover 20 connects the rear cover 10 and close the opening 12. The rear cover 10 and the front cover 20 forms a confined space. A plurality of LEDs 30 cluster together on a substrate secured to the inner wall 11 and forms a high concentrated light source. The front cover 20 further includes a light-distribution lens 21 opposite to the plurality of LEDs 30. Furthermore, in the confined space, there is a Fresnel lens 40 placed between the light-distribution lens 21 and the plurality of LEDs 30.

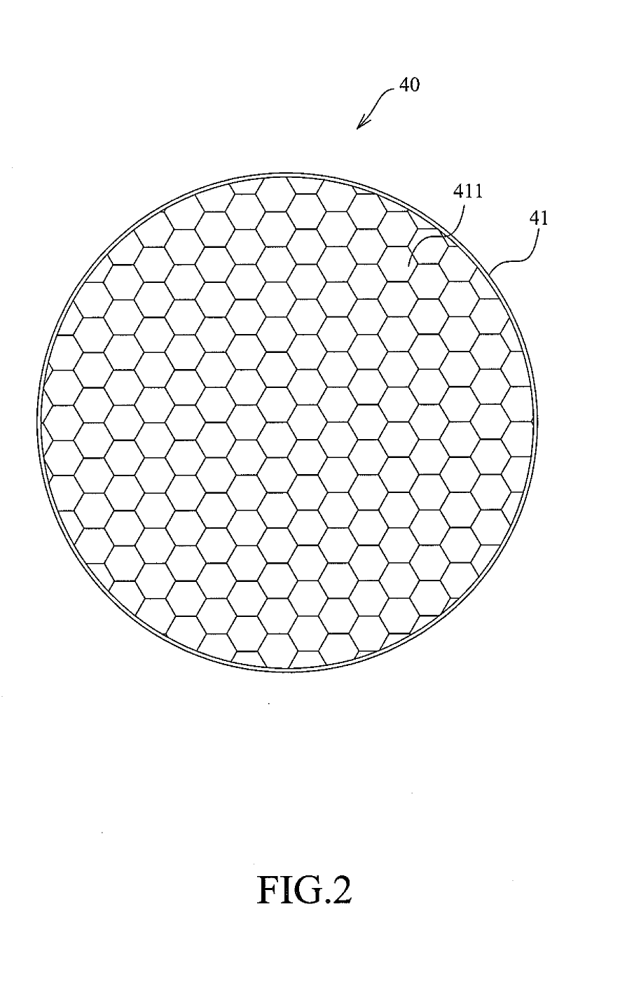

FIG. 2 is a plan view illustrating an inner curved side 41 of the Fresnel lens 40 in accordance with FIG. 1. The inner curved side 41 faces to the plurality of LEDs 30. The inner curved side 41 has a plurality of spherical prominences 411 which are defocusing lenses. Through the spherical prominences 411, the LED traffic signal device 100 can have uniform brightness. The plurality of spherical prominences 411 are honeycomb-arranged throughout the entire inner curved side 41. The amount, shape or size of the spherical prominence 411 depends upon the requirement in a practical design. In this embodiment, the spherical prominence 411 is a hexagon, while the invention is not limited thereto. In another embodiment, the shape of the spherical prominence 411 can be any suitable style, such as pentagon, octagon or polygon in equilateral or scalene.

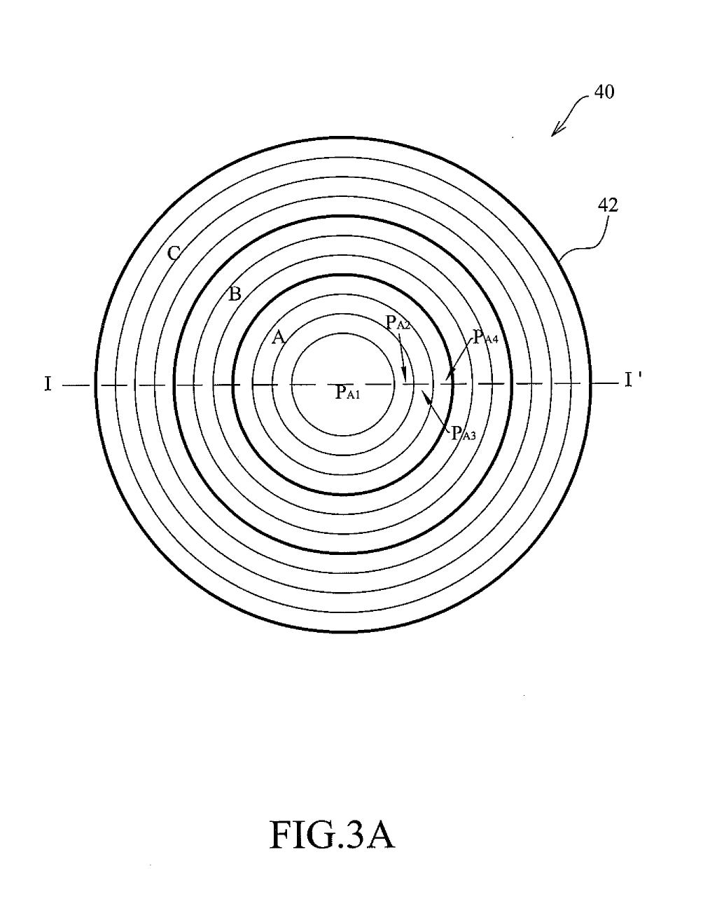

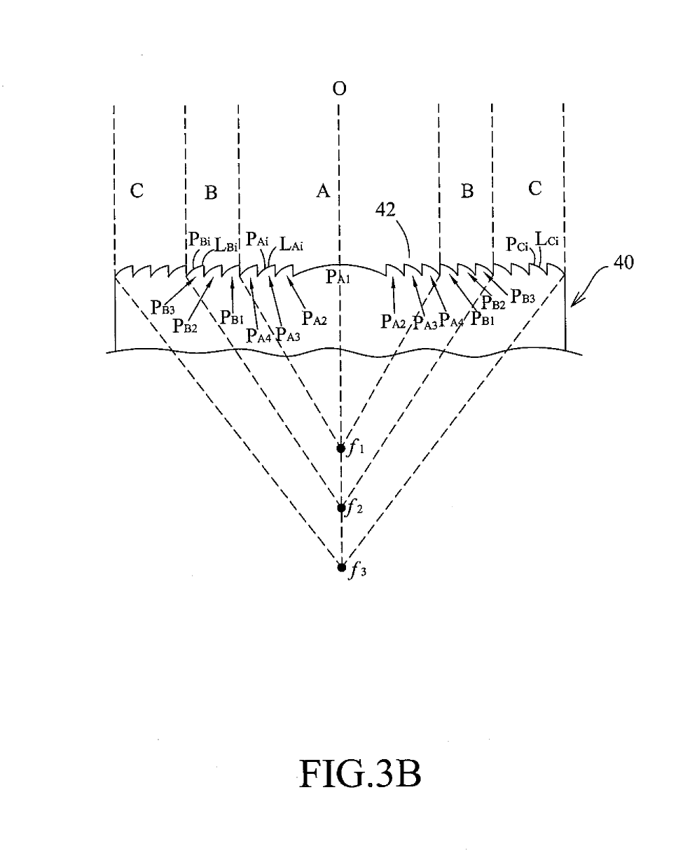

FIG. 3A is a plan view illustrating an outer curved side 42 of the Fresnel lens 40, which has typical Fresnel structure for collimating light emitted from the plurality of LEDs 30. FIG. 3B is a partial cross-sectional view of the Fresnel structure along the dotted line I-I′ of FIG. 3A. As shown in FIGS. 3A and 3B, the outer curved side 42 is divided into three sections A, B and C respectively having different radiuses of curvature R₁, R₂ and R₃ corresponding to different focal distances f₁, f₂, and f₃. The radiuses of curvature R₁, R₂ and R₃ are respectively defined by spherical S_{A}, S_{B} and S_{C} (not shown). The sections A, B and C are coaxially arranged with respect to an optical axis O. Note that in this embodiment three sections are given for illustration purpose while the present invention is not limited thereto. In another embodiment of the present invention, there may have Fresnel structure with two sections, four sections or any other multiple sections respectively corresponding to different focus distances.

Still referring to FIGS. 3A and 3B, the sections A, B and C respectively comprises at least one annular prism elements P_{Ai}, P_{Bi}, and P_{Ci} arranged with respect to the optical axis O. The annular prism elements P_{Ai}, P_{Bi} and P_{Ci} respectively comprise inclined planes L_{Ai}, L_{Bi}, and L_{Ci}. The inclined planes L_{Ai}, L_{Bi}, and L_{Ci} are respectively a part of the spherical S_{A}, S_{B} and S_{c} having the radiuses of curvature R₁, R₂ and R₃. The term “i” refers to the number of the annular prism element. For example, in this embodiment, the section A includes four annular prism elements P_{A1}, P_{A2}, P_{A3}, and P_{A4} corresponding to the same radiuses of curvature R₁. The section B includes three annular prism elements P_{B1}, P_{B2}, and P_{B3} corresponding to the same radiuses of curvature R₂. The annular prism elements P_{Ci} of the section C should be understood according to the aforementioned. Note that the annular prism elements P_{Ai}, P_{Bi}, and P_{Ci} are coaxially arranged with respect to the optical axis O at a predetermined pitch. The pitch can be regular or irregular depending upon the design requirements. Also, the number of the annular prism elements in each section can vary without being limited by FIGS. 3A and 3B.

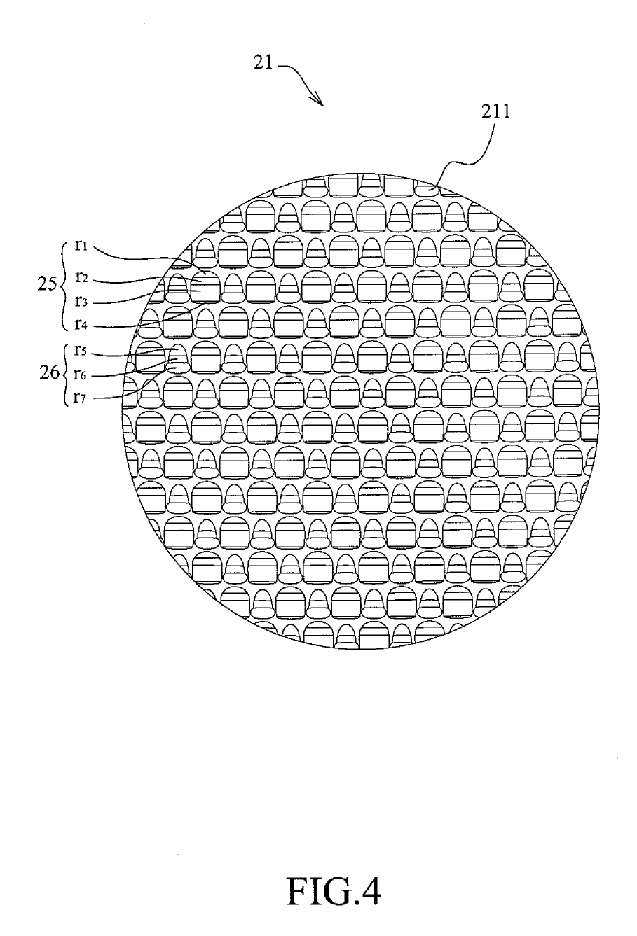

Referring to FIG. 1, the light-distribution lens 21 is formed with a light-incident surface 211 facing the plurality of LEDs 30 and an out-light surface 212 back of the light-incident surface 211. The out-light surface 212 is typically smooth and should not be contaminated easily by dust. The pattern of the light-incident surface 211 can vary in order to obtain a spread light distribution with uniform brightness within the desired angular range. As shown in FIG. 4, the light-incident surface 211 comprises multiple first convex units 25, each first convex unit 25 having at least two curved areas, such as the curved areas r₁, r₂, r₃ and r₄. The curved areas r₁, r₂, r₃ and r₄, either being spherical or aspherical, can have any shapes and sizes depending upon the design requirements. In this embodiment, the light-incident surface 211 further comprises multiple second convex units 26 different from the first convex units 25, each second convex unit 26 having at least two curved regions, such as the curved regions r₅, r₆, and r₇, as shown in FIG. 4. The curved regions r₅, r₆, and r₇, either being spherical or aspherical, can have any shapes and sizes depending upon the design requirements. In this embodiment, any of the curved areas r₁, r₂, r₃ and r₄ has a curvature larger than any of the curved regions r₅, r₆, and r₇ does. In another embodiment, there may be only one, among the curved areas r₁, r₂, r₃ and r₄, having a curvature larger than any of the curved regions r₅, r₆, and r₇ does. Additionally, the present invention includes all embodiments wherein the first convex unit 25 and the second convex unit 26 are different. Furthermore, the present invention also includes embodiments having only the first convex unit 25 or only the second convex unit 26.

In addition, as shown in FIG. 4, the multiple first convex units 25 and the multiple second convex units 26 are arranged throughout the light-incident surface 211. The first convex units 25 and the second convex units 26 can be interlaced-arranged and/or arrayed-arranged wherein each first convex unit 25 and each second convex unit 26 are separated. The present invention also includes one embodiment wherein each first convex unit 25 and each second convex unit 26 are connected.

Although specific embodiments have been illustrated and described, it will be obvious to those skilled in the art that various modifications may be made without departing from what is intended to be limited solely by the appended claims.

What is claimed is:

1. A LED traffic signal device, comprising:
a plurality of light emitting diodes;
a light-distribution lens having a light-incident surface formed with multiple first convex units facing the plurality of light emitting diodes, each first convex unit having at least two curved areas defined by different curvatures; and
a Fresnel lens arranged between the plurality of LEDs and the light-distribution lens, the Fresnel lens having multiple sections coaxially arranged with respect to an optical axis, every section having a different radius of curvature corresponding to a different focal distance.

2. The LED traffic signal device of claim 1, wherein every section is formed with at least one annular prism element coaxially arranged with respect to an optical axis

3. The LED traffic signal device of claim 1, wherein every section is formed with at least one annular prism element having a spherical surface corresponding to the radius of curvature of the section.

4. The LED traffic signal device of claim 1, wherein the light-distribution lens further comprises multiple second convex units on the light-incident surface facing the plurality of light emitting diodes, and the second convex unit and the first convex unit are different.

5. The LED traffic signal device of claim 4, wherein each second convex unit comprises at least two curved regions defined by different curvatures, and the curvature of one of the first convex units is greater than the curvature of one of the second convex units.

6. The LED traffic signal device of claim 4, wherein each second convex unit comprises at least two curved regions defined by different curvatures, and any of the curved areas has a curvature larger than any of the curved regions does.

7. The LED traffic signal device of claim 4, wherein the multiple first convex units and the multiple second convex units are interlaced-arranged.

8. The LED traffic signal device of claim 1, wherein the multiple first convex units are arrayed-arranged.

9. The LED traffic signal device of claim 4, wherein the multiple first convex units and the multiple second convex units are arrayed-arranged.

10. The LED traffic signal device of claim 4, wherein each first convex unit and each second convex unit are separated.

11. The LED traffic signal device of claim 4, wherein each first convex unit and each second convex unit are connected.
